(19) United States
(12) Patent Application Publication
(10) Pub. No.: US 2013/0268418 A1
(43) Pub. Date: Oct. 10, 2013

(54) METHODS AND APPARATUS FOR WIRELESS COMMUNICATION OF TIME AND ATTENDANCE INFORMATION

(71) Applicant: ACCU-TIME SYSTEMS, INC., Ellington, CT (US)

(72) Inventors: Stephen Sardi, Bethany, CT (US); David Hopkins, Sarasota, FL (US)

(73) Assignee: Accu-Time Systems, Inc., Ellington, CT (US)

(21) Appl. No.: 13/856,952

(22) Filed: Apr. 4, 2013

Related U.S. Application Data
(60) Provisional application No. 61/620,068, filed on Apr. 4, 2012.

(51) Int. Cl. G06Q 10/10

(52) U.S. Cl. CPC G06Q 10/1091
USPC 705/32

(57) ABSTRACT

Methods and apparatus for wireless communication of time and attendance information are disclosed. A time and attendance device may include a receiving unit and a transmitting unit. The receiving unit may be configured to receive identification information that identifies at least one user of the time and attendance device. The transmitting unit may be configured to transmit the received identification information to an external server over the wireless network. Related time information that indicates a time at which the receiving unit received the identification information may be captured and also transmitted to the external server.

### CROSS REFERENCE TO RELATED APPLICATION

This application claims the benefit of U.S. Provisional Application No. 61/620,068 filed Apr. 4, 2012, which is incorporated by reference as if fully set forth.

### BACKGROUND

Many employers use time and attendance devices to track employee work time and attendance. Such time and attendance devices may range in complexity from simple punch clocks to more advanced devices equipped with biometric sensors or card swipes to enable more secure employee clock in and verification.

Depending on the nature of an employer's business, an employer may simply need to purchase and implement a single time and attendance device at one employment location. However, some employers need to purchase and implement many time and attendance devices at many different employment locations, some of which may not be staffed by a manager and/or information technology (IT) specialist.

### SUMMARY

Methods and apparatus for wireless communication of time and attendance information are disclosed. A time and attendance device may include a receiving unit and a transmitting unit. The receiving unit may be configured to receive identification information that identifies at least one user of the time and attendance device. The transmitting unit may be configured to transmit the received identification information to an external server over the wireless network. Related time information that indicates a time at which the receiving unit received the identification information may be captured and also transmitted to the external server.

In an embodiment, the transmitting unit may be further configured to transmit location information to the external server over the wireless network in response to the receiving unit receiving the identification information. The location information may identify a location of the time and attendance device at the time the identification information was received. A global positioning unit may provide the location information to the transmitting unit.

### BRIEF DESCRIPTION OF THE DRAWING(S)

A more detailed understanding may be had from the following description, given by way of example in conjunction with the accompanying drawings wherein:

FIG. 1 is a block diagram of an example wireless system;

FIG. 2 is a block diagram of an example time and attendance device; and

FIG. 3 is a flow diagram of an example method for wireless transmission of time and attendance information.

### DETAILED DESCRIPTION OF EMBODIMENTS

For employers that operate more than one work site, for example, ease of setup of time and attendance devices may be of concern. This may be especially true for employers that operate work sites that do not include a full staff (e.g., one or more work sites do not have a full time manager and/or IT personnel). Employee verification may also be of concern for these employers. For example, if an employee works at a location that does not have a full time manager, it may be easy for the employee to have a friend clock in for him or her or to log in from a different location. Such an employee may never actually show up to work at the site that he or she is scheduled to work at, and may nevertheless be paid for work he or she never completed.

Methods and apparatus described herein may provide for a time and attendance device that is easy to set up at a remote location and may wirelessly transmit time and attendance data to a remote database where time and attendance data for employees working at multiple different work sites may be stored. Methods and apparatus described herein may also include wireless transmission of location data with the time and attendance data, for example, to verify that the employee clocked in to the time and attendance device at the work location. In an embodiment, the time and attendance device may include a global positioning (GPS) device that may provide the location of the device at the time of clock in.

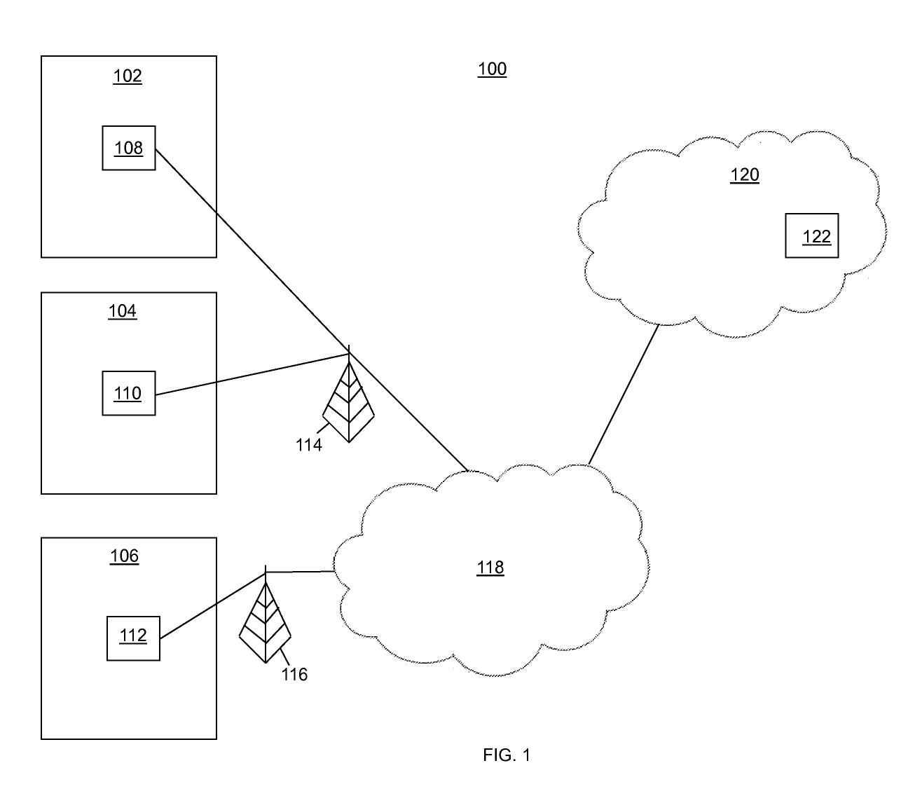

FIG. 1 is a block diagram of an example wireless system 100. The illustrated wireless system 100 includes multiple worksites 102, 104 and 106 that may be operated by a particular employer. The illustrated wireless system 100 also includes a managed network 120 that may be, for example, operated by the particular employer. The managed network 120 may include a time a time and attendance database 122. Each work site 102, 104 and 106 may include at least one time and attendance device (e.g., time and attendance devices 108, 110 and 112 illustrated in FIG. 1), each of which may be in communication with a communications interface. For example, in the example wireless system illustrated in FIG. 1, the time and attendance devices 108 and 110 are in communication with a base station 114, and the time and attendance device 112 is in communication with the base station 116. The communications interface(s) may relay information from the time and attendance devices 108, 110 and 112 to the managed network 120.

The time and attendance devices 108, 110 and 112 may be any type of wireless device that is configured to receive time and attendance information and wireless transmit information. By way of example, the time and attendance devices 108, 110 and 112 may include one or more of a clock-in terminal with wireless capability, a cellular telephone, a personal computer (PC) and a personal data assistant (PDA). The time and attendance devices 108, 110 and 112 may be pre-configured to always be connected to the wireless network 118 and may be pre-configured to send time and attendance information to a pre-configured IP address (e.g., the IP address of a server operating the time and attendance database 122).

In the example illustrated in FIG. 1, the base stations 114 and 116 are base stations on a wireless network 118. The wireless network 118 may be any type of wireless network, including, for example, a cellular telephone network (e.g., a code division multiple access (CDMA) network or a global system for mobile communications (GSM) network) and the Internet. Further, while one wireless network 118 and two base stations 114 and 116 are illustrated in FIG. 1, the time and attendance devices may transmit information to the managed network 120 via any combination of different networks and communications interfaces.

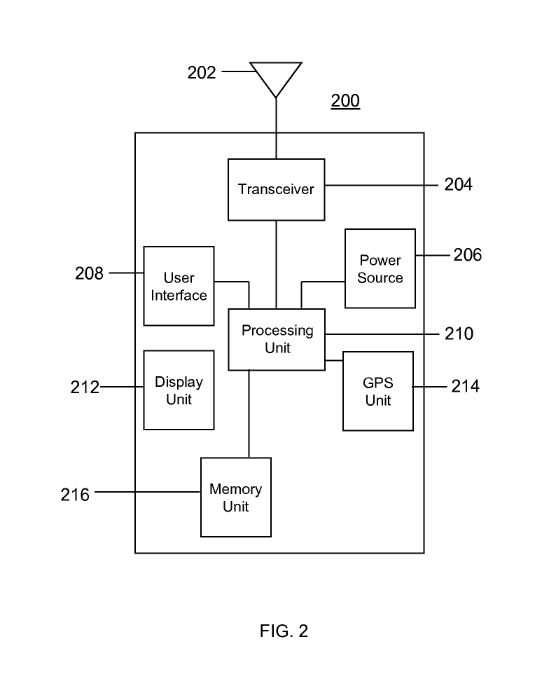

FIG. 2 is a block diagram of an example time and attendance device 200. The illustrated time and attendance device 200 includes a processing unit 210, a transmit/receive unit 202, a transceiver 204, a power source 206, a user interface 208, a display unit 212, a GPS unit 214, and a memory unit 216. Embodiments of a time and attendance device may include any sub-combination of the elements illustrated in FIG. 2 and may further include additional features not shown.

The processing unit 210 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGA) circuits, any other type of integrated circuit (IC), a state machine, and the like. The processing unit 210 may perform signal coding, data processing, power control, input/output processing, and/or any other functionality that may enable the time and attendance device 200 to operate in a wireless environment. The processing unit 210 may be coupled to the transceiver 204, which may be coupled to the transmit/receive element 202.

The transceiver 204 may be configured to modulate the signals that are to be transmitted by the transmit/receive unit 202 and demodulate the signals that are received by the transmit/receive unit 202. The time and attendance device 200 may have multi-mode capabilities. Thus, the transceiver 204 may include multiple transceivers for enabling the time and attendance device 200 to communicate via multiple radio access technologies (RATs), such as universal terrestrial radio access (UTRA) and Institute of Electrical and Electronics Engineers (IEEE) 802.11, for example.

The transmit/receive element 202 may be configured to transmit signals to, and/or receive signals from, an interface element (e.g., 114 and 116) over an air interface. In an embodiment, the transmit/receive element 202 may be an antenna configured to transmit and/or receive radio frequency (RF) signals. In another embodiment, the transmit/receive element 202 may be an emitter/detector configured to transmit and/or receive infrared (IR), ultraviolet (UV), or visible light signals, for example. In another embodiment, the transmit/receive element 202 may be configured to transmit and receive both RF and light signals. The transmit/receive element 202 may be configured to transmit and/or receive any combination of wireless signals.

The processing unit 210 may be coupled to, and may receive user input from, the user interface 208 and/or the display unit 212 (which may be, in an embodiment, a touch screen). The processing unit 210, the user interface 208 and/or the display unit 212 may be configured to capture time information associated with the receipt of identification information of a user.

The processing unit 210 may also output user data to the user interface 208 and/or the display unit 212. Additionally, the processing unit 210 may access information from, and store data in, any type of suitable memory, such as the memory unit 216. The memory unit 216 may include one or more memory devices (e.g., a non-removable memory, a removable memory or a combination thereof). Examples of non-removable memory may include a subscriber identity module (SIM) card, a memory stick, a secure digital (SD) memory card, etc. The processing unit 210 may also access information from, and store data in, memory that is not physically located on the time and attendance device 200, such as on a server (e.g., a server on the managed network 120 operating the time and attendance database 122 illustrated in FIG. 1).

The processing unit 210 may receive power from the power source 206 and may be configured to distribute and/or control power to other components in the time and attendance device 200. The power source 206 may be any suitable device for powering the time and attendance device 200 (e.g., one or more batteries, solar cells, etc.).

The user interface 208 may be any type of user interface configured to receive time and attendance information from a user. For example, the user interface 208 may include one or more of a card reader, a key pad, an iris scanner, a fingerprint reader, etc. A plurality of types of user interface may be required to aid in the prevention of erroneous attendance information being entered.

In an embodiment, the processing unit 210 is coupled to a GPS unit 214, which may be configured to provide location information (e.g., longitude and latitude) regarding the current location of the time and attendance device. In addition, or in lieu of, receiving location information from a GPS unit 214, the processing unit 210 may be configured to receive location information over the air interface from an interface unit (e.g., base stations 114 and 116) and/or determine its location based on the timing of signals being received from two or more nearby base stations. Generally, the transmitting unit may be configured to transmit received identification information and related time information in a transmission that enables an external server to identify a location of the time and attendance device at the time the identification information was received.

In other embodiments (not illustrated in FIG. 2), the processor may be further coupled to other peripherals, which may include one or more of software and/or hardware modules that may provide additional features, functionality and/or wired or wireless connectivity. For example, the peripherals may include a universal serial bus (USB) port, a Bluetooth® module, etc.

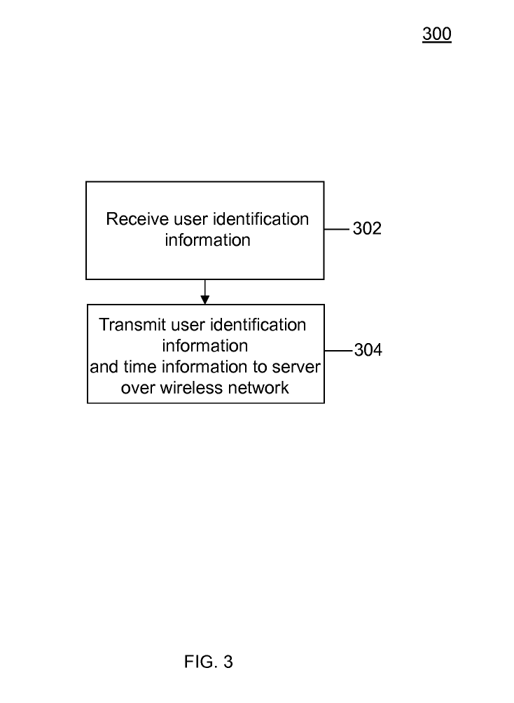

FIG. 3 is a flow diagram 300 of an example method for wireless transmission of time and attendance information. According to the illustrated method, a time and attendance device (e.g., one of the time and attendance devices 108, 110 and 112 illustrated in FIG. 1) receives user identification information (302). The time and attendance device may transmit the user identification information and related time information that is captured in connection with the receipt of the user identification information to an external server (e.g., the time and attendance server 122 illustrated in FIG. 1).

In an embodiment, the time and attendance device 200 illustrated in FIG. 2 may receive the user identification information via the user interface 208. In an embodiment, the processing unit 210 may process the user identification information and/or provide the user identification information to the transceiver 204 for transmission to the external server via the transmit/receive unit 202 in response to receiving the user identification information. Information about the time that the user identification information was received by the time and attendance device may also be transmitted to the external server in response to the user interface 208 receiving the user identification information. In another embodiment, the transmit/receive unit 202 may receive a request for information (e.g., from a server on the managed network 120). In response to receiving the request for information, the transmit/receive unit 202 may transmit the identification information to the external server. The transmit/receive unit 202 may also transmit information about the time that the identification information was received by the time and attendance device in response to receiving the request for information.

In another embodiment, the time information may not be transmitted by the time and attendance device but may be determined by the managed network 120 and stored in the external database. In one example, the time may be determined by the network based on the time of receipt of the identification information.

In an embodiment, the processing unit 210 may obtain location information (e.g., from the GPS unit 214 or the base stations 114 and 116) identifying the location of the time and attendance device 200 at the time that user information was entered. The transmit/receive unit 202 may transmit the location information to the external server over the wireless network 118.

As described briefly above, the time and attendance device 210 may be pre-configured to always be connected to the wireless network and to transmit data to a pre-configured IP address (e.g., the IP address of a server operating the time and attendance database 122), for example, at the time of manufacturer. If the time and attendance device includes a SIM card, the SIM card may be activated before receipt by the employer. Accordingly, when the employer receives the time and attendance device, the employer need only power the device on. The device may be pre-configured to establish communication with the wireless network 118 and to transmit specific data (e.g., one or more of user identification information, time information and location information) to the desired external server over the wireless network 118. This may avoid the need for setup of the time and attendance device at a remote site by an IT professional.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a time and attendance device, base station, radio network controller (RNC), or any host computer.

What is claimed is:

1. A time and attendance device comprising:
a receiving unit configured to receive identification information of users of the time and attendance device;
a time capture component configured to capture time information indicating a time at which the receiving unit received identification information of a user; and
a transmitting unit configured to transmit received identification information of a user and related time information to an external server over a wireless network.

2. The time and attendance device of claim 1, wherein the transmitting unit is configured to transmit the received identification information and the related time information to the external server in response to the receiving unit receiving the identification information.

3. The time and attendance device of claim 1, wherein:
the receiving unit is configured to receive a request for information; and
the transmitting unit is configured to transmit the received identification information and the related time information to the external server in response to the receiving unit receiving the request for information.

4. The time and attendance device of claim 1, wherein the transmitting unit is configured to transmit the received identification information and the related time information in a transmission that enables the external server to identify a location of the time and attendance device at the time the identification information was received.

5. The time and attendance device of claim 4, further comprising a global positioning unit configured to provide to the transmitting unit location information identifying the location of the time and attendance device at the time the identification information was received for inclusion in the transmission.

6. The time and attendance device of claim 1, wherein the wireless network is a cellular network and/or a wireless connection to the Internet.

7. The time and attendance device of claim 1, wherein the receiving unit is a user interface.

8. The time and attendance device of claim 7, wherein the user interface comprises one or more of a touch screen, a card reader, a key pad, an iris scanner, and a fingerprint reader.

9. The time and attendance device of claim 1, wherein the time and attendance device is pre-configured to communicate with a managed network including the external server.

10. The time and attendance device of claim 9, wherein the transmitting unit is pre-configured to transmit the information and the received identification information to a pre-configured internet protocol (IP) address.

11. The time and attendance device of claim 9, wherein the time and attendance device is pre-configured to be activated within the managed network in response to power up of the time and attendance device.

12. A method of wireless communication for a time and attendance device comprising:
receiving identification information that identifies a user of a time and attendance device; and
transmitting the received identification information and related time information that is captured in connection with the receipt of the identification information to an external server over a wireless network.

13. The method of claim 12, wherein the transmitting further includes transmitting the received identification information and the related time information to the external server in response to receiving the identification information.

14. The method of claim 12, further comprising receiving a request for information, wherein the received identification information and the related time information are transmitted to the external server in response to receiving the request for information.

15. The method of claim 13, wherein the transmitting the received identification information and the related time information is in connection with a transmission that enables the external server to identify a location of the time and attendance device at the time the identification information was received.

16. The method of claim 15, wherein the transmission includes global positioning data from a global positioning unit as location information identifying the location of the time and attendance device at the time the identification information was received.

17. The method of claim 12, wherein the identification information is received via one or more of a touch screen, a card reader, a key pad, an iris scanner, a fingerprint reader and another type of user interface.

18. The method of claim 12, further comprising establishing wireless communication with a managed network including the external server based on a pre-configuration of the time and attendance device.

19. The method of claim 18, wherein the establishing wireless communication is in response to power up of the time and attendance device.

20. The method of claim 12, wherein the transmitting the received identification information and the related time information is to an internet protocol (IP) address with which the time and attendance device is pre-configured.
